(19) United States
(12) Patent Application Publication
(10) Pub. No.: US 2019/0236597 A1
(43) Pub. Date: Aug. 1, 2019

(54) SYSTEMS AND METHODS FOR ASSOCIATING A USER'S SHOPPING EXPERIENCES ACROSS MULTIPLE CHANNELS

(71) Applicant: Walmart Apollo, LLC, Bentonville, AR (US)

(72) Inventors: Jian Huang, Santa Clara, CA (US); Gajendra Kamat, Cupertino, CA (US); Sushant Kumar, Sunnyvale, CA (US); Abhijeet Karnik, San Jose, CA (US)

(21) Appl. No.: 15/881,334

(22) Filed: Jan. 26, 2018

(51) Int. Cl. G06Q 20/38; G06Q 30/02; G06F 17/30

(52) U.S. Cl. CPC G06Q 20/389; G06F 17/30286; G06Q 30/0201

(57) ABSTRACT

Systems and methods for synchronizing a customer's shopping experience over multiple channels are disclosed. A transaction record is generated in response to a purchase of goods, and transaction data is extracted from the transaction record and stored in a transaction database. Customer identities are extracted from the transaction record and stored in a customer identity database, wherein the transaction data extracted from the transaction record is associated with the customer identities. A plurality of customer identities are identified that are associated with a user and those identified customer identities that are applicable to the use case of the system are determined. Use case specific information is generated based, at least in part, on transaction data associated with each of the determined customer identities.

### TECHNICAL FIELD

This application relates generally to monitoring a user's shopping behavior across multiple channels and, more particularly, relates to synchronizing a user's shopping behavior across multiple channels.

### BACKGROUND

Customers may shop with a retailer through a variety of channels. For example, they may go to a physical store front and purchase goods, or they may purchase goods from the store's online website. Alternatively, a customer may purchase goods from the store's mobile application or through other similar means. However, a customer's shopping experience in one channel may not be linked to the same customer's shopping experience in another channel. For example, a customer's purchase history at a physical store front may not be linked to the customer's purchase from the store's online website.

Linking a customer's in store shopping profile or history to their online experience, as well as any shopping they may do through a mobile application, would provide many benefits to the customer. Such benefits include easy reordering of previously purchased goods, cross channel personalization and targeting, cross channel advertising and marketing campaigns, offline to online conversion, and data science models having a comprehensive view of customers.

At least some known approaches to synchronizing a customer's shopping experience over various mediums have been tried. For example, some systems attempt to utilize proxies such as the name of the transaction and/or the store number where the purchase was made. Other existing systems attempt to match users who have shopped in different mediums by matching their name and the zip code they reside in to the zip code of the store where the purchase was made. However, these approaches have proven ineffective in providing a robust matching system for synchronizing a customer's shopping experience over two or more different mediums.

### SUMMARY OF THE INVENTION

The embodiments described herein enable the synchronization of a customer's shopping experience with a retailer over a plurality of channels. For example, in one embodiment, a system for synchronizing a customer's shopping experience of multiple channels is disclosed. The system comprises a plurality of user interface devices, each interface device of the plurality of interface devices configured to generate a transaction record in response to a purchase of goods. The system further comprises a server configured to receive a transaction record and extract transaction data from the transaction record and store the transaction data in a transaction database. The server is further configured to extract at least one customer identity from the transaction record and store the at least one customer identity in a customer identity database, wherein the transaction data extracted from the transaction record is associated with the at least one customer identity. The server identifies a plurality of customer identities that are stored in the customer database that are related to the user and determines which of the identified plurality of related customer identities are applicable to a use case of the system. The server generates use case specific information based, at least in part, on the transaction data associated with the determined one or more customer identities.

In other embodiments, a method for synchronizing a customer's shopping experience over multiple channels is disclosed. The method includes receiving a transaction record generated in response to a purchase of goods, extracting transaction data from the transaction record and storing the transaction data in a transaction database. Customer identities are extracted from the transaction record and stored in a customer identity database, wherein the transaction data extracted from the transaction record is associated with the customer identities. A plurality of customer identities that are stored in the customer database and related to the user are identified and those customer identities that are applicable to a use case of the system are determined. Use case specific information is generated based, at least in part, on transaction data associated with each of the determined customer identities.

In still other embodiments, a non-transitory computer readable medium is disclosed, having instructions stored thereon for synchronizing a customer's shopping experience over multiple channels. The instructions, when executed by a processor, cause a device to perform operations for such synchronization. The device may receive a transaction record generated in response to a purchase of goods, extracting transaction data from the transaction record and store the transaction data in a transaction database. The device may extract customer identities from the transaction record and store them in a customer identity database, as well as associate the transaction data extracted from the transaction record with the customer identities. The device may identify a plurality of customer identities that are stored in the customer database that are related to the user and determine which of the identified plurality of related customer identities are applicable to a use case of the system. The device may generate use case specific information based, at least in part, on transaction data associated with each of the determined customer identities.

### DESCRIPTION OF THE DRAWINGS

FIG. 1A illustrates an exemplary system in accordance with some embodiments of the present disclosure.

FIG. 1B illustrates an exemplary hardware/software diagram in accordance with some embodiments of the present disclosure.

FIG. 2 illustrates an exemplary computing device in accordance with some embodiments of the present disclosure.

FIG. 3A illustrates an exemplary customer identity graph in accordance with some embodiments of the present disclosure.

FIG. 3B illustrates the customer identity graph of FIG. 3A after application of linkage rules.

FIG. 4 illustrates an exemplary online shopping interface in accordance with some embodiments of the present disclosure.

FIG. 5 illustrates an exemplary flow diagram of a method in accordance with some embodiments of the present disclosure.

### DETAILED DESCRIPTION

As discussed above, current shopping experience synchronization methods have proven ineffective in providing a robust matching system for synchronizing a customer's shopping experience over two or more different channels. The embodiments described herein enable the robust matching of customer identities associated with a single user based on a use case. Examples of such use cases may include easy re-ordering, cross channel personalization and targeting, cross channel advertising and marketing campaigns, offline to online conversion, and data science models requiring a comprehensive view of customers, among others. The embodiments described herein include, for example, extraction of one or more customer identities from a transaction record. The embodiments also include identification of customer identities that are potentially associated with a single user and subsequent graphing of those potentially associated customer identities. The embodiments described herein also provide for the determination of which of the potentially associated customer identities are actually associated with a single user based on a set of linkage rules. Although the embodiments described herein illustrate systems and methods used for synchronizing a user's shopping experience over a plurality of channels, the embodiments discussed herein are not limited to such systems and methods and one of ordinary skill in the art will appreciate that the current disclosure may be used in connection with any type of system or method that addresses various different types of synchronization problems.

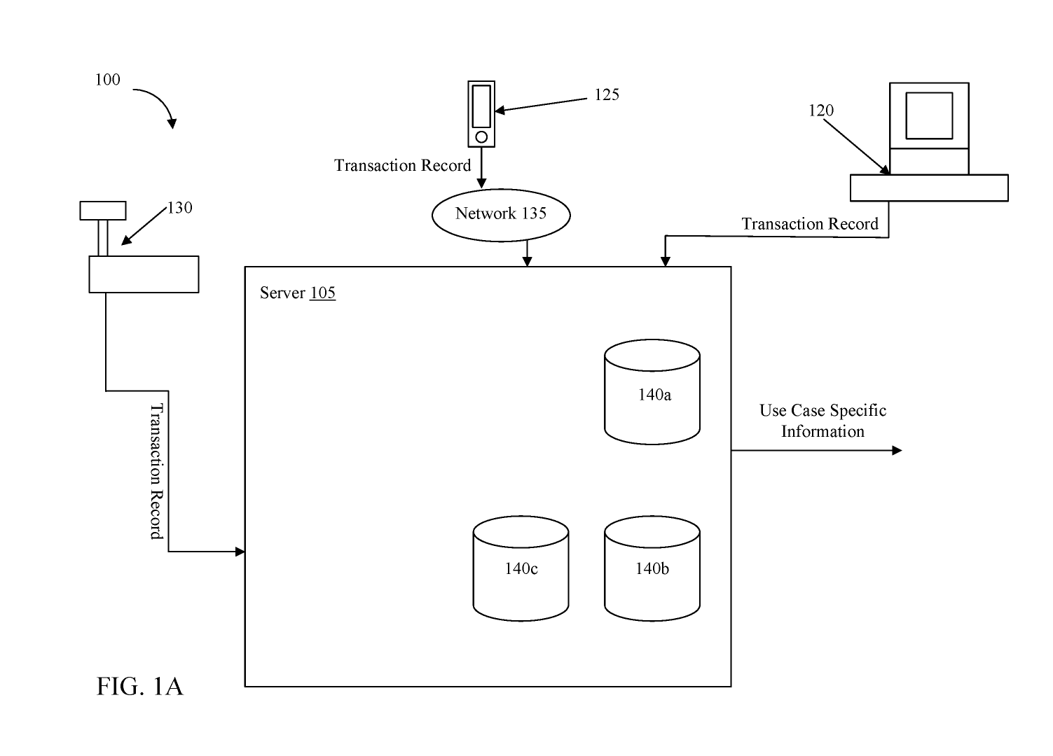

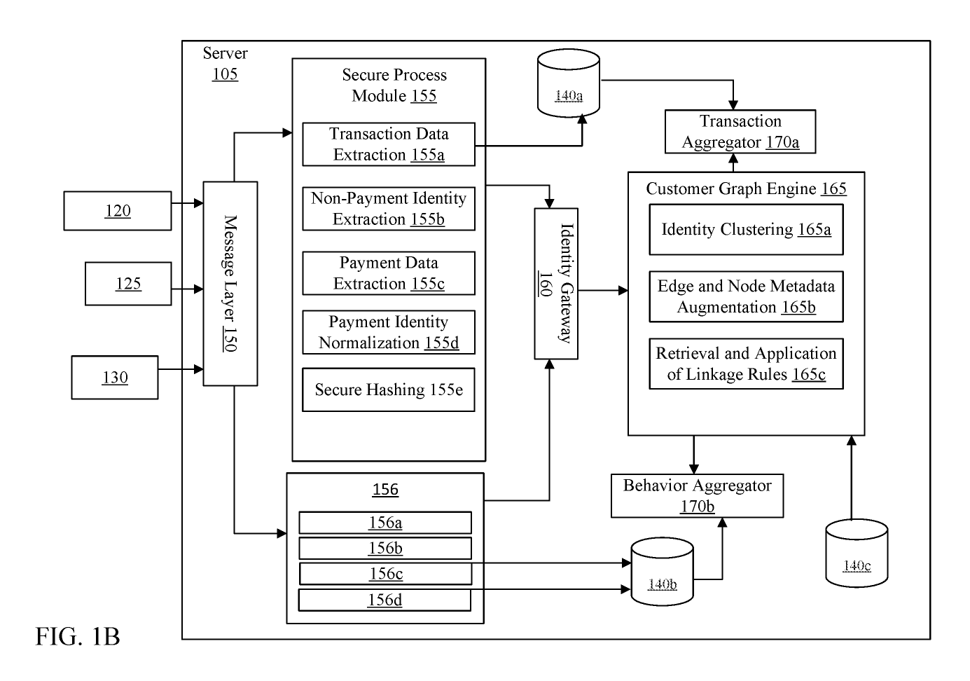

FIG. 1A illustrates a functional block diagram of an exemplary system 100 in accordance with some embodiments of the present disclosure. System 100 may include a server 105, including database storage modules 140a, 140b, and 140c. Although illustrated as incorporated within server 105, database storage modules 140a, b, and c may be implemented separately from server 105 as well. Server 105 is illustrated as a single server in FIG. 1A for ease of illustration only, and may be implemented as a cluster of servers in some embodiments. System 100 may further include an online order system 120, a mobile device 125, and an in store (point of sale) terminal 130, each of which is a computing device that may represent a channel through which a user can purchase goods from a retailer. Each of the computing devices 120, 125, and 130 may be communicatively coupled to the server 105. It should be noted that, as used herein, the term “couple” is not limited to a direct mechanical, communicative, and/or an electrical connection between components, but may also include an indirect mechanical, communicative, and/or electrical connection between two or more components or a coupling that is operative through intermediate elements or spaces.

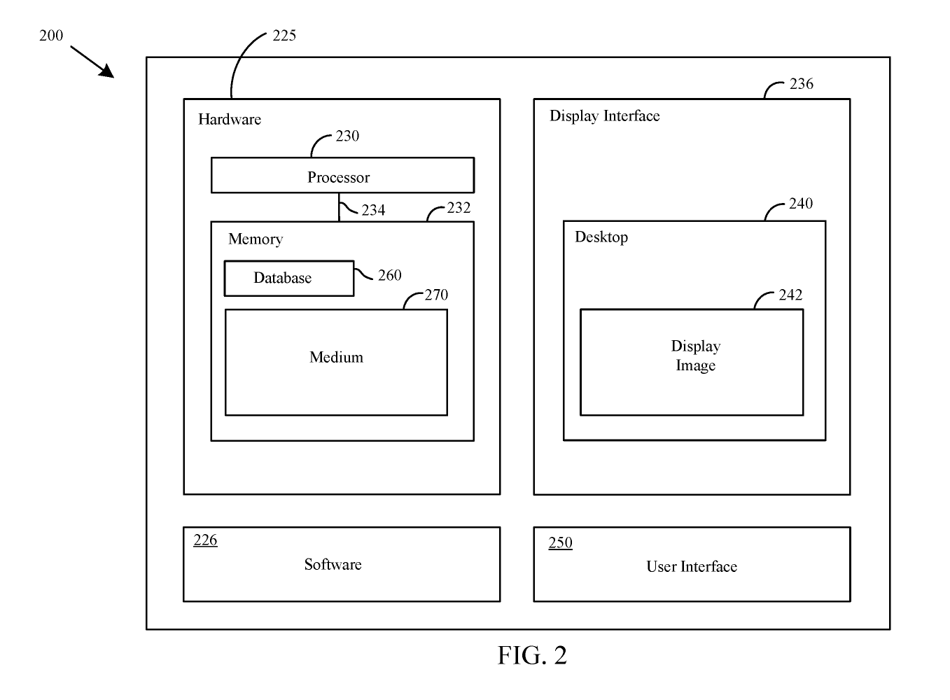

Server 105, online order system 120, mobile device 125, and in store (point of sale) terminal 130 may be examples of computing devices that can be, for example, a desktop computer, laptop, mobile device, tablet, thin client, or other device having a communications interface (not shown) that can communicate with other components of system 100, as explained in more detail below with respect to FIG. 2.

In some embodiments, server 105 may be associated with a retail store having a plurality of channels through which a user may purchase goods from the retailer. Server 105 may be linked to customer interface devices from each of these channels and configured to receive and process transaction records generated by the customer interface devices.

In some embodiments, each customer interface device 120, 125, and 130, can be configured to facilitate a purchase of goods from the retailer, and then communicate data about the purchase to server 105. For example, each user terminal 120, 125, and 130 can be capable of processing a purchase, and connecting to, for example, the internet to communicate a transaction record of the purchase to server 105 via network 135.

FIG. 1B illustrates a hardware/software block diagram of the system 100 in accordance with some embodiments of the present disclosure. System 100 may be designed to synchronize a customers shopping experience over multiple shopping channels by linking customer identities associated with the user that are generated from each of the channels. The server 105 may be configured to execute each of the modules described with respect to FIG. 1B in order to determine which customer identities are linked. More specifically, message layer 150 may receive transaction records and behavioral events from online order system 120, a mobile device 125, and an in store (point of sale) terminal 130. Message layer 150 may store and sequence the received records and events for further processing by the secure process module 155. In some embodiments, message layer 150 may be an implementation of the Apache Kafka messaging system. The secure process module 155 and behavioral events process module 156 are configured to read and process customer transaction and behavioral records from message layer 150.

Transaction events process module 155 may parse and extract detailed transaction data 155a from transaction records. Transaction data extracted may include the items purchased, the item quantity, the price of each item, the channel through which the items were purchased, the product category, and the date of purchase. All extracted transaction data may be stored in transaction database 140a. Transaction events process module 155 may also extract non-payment customer identities 155b, which are not associated with payment instruments. Some examples of non-payment customer identities are online account ID, email address, guest checkout cookie of non-registered customers. Transaction events process module 155 may also extract payment data 155c from the transaction records, such as credit card number, cardholder name and expiry date. Transaction events process module 155 may normalize the payment data 155d and perform a secure hashing function on the normalized payment data 155e to generate payment customer identities. The generated payment customer identities may be used to differentiate customer identities in one or multiple shopping channels.

Behavioral events process module 156 may parse and extract customer identities 156a from behavioral events. The behavioral events process module 156 may extract online behavioral events 156c such as item page views, search keywords, add-to-cart actions. The behavioral events process module 156 may also extract in-store behavioral events 156d such as store visits, as well as store order pickup and return. Similarly, the extracted behavioral data are stored in behavior database 140b. Behavioral events may contain one or multiple customer identities. For example, behavioral events processing module 156 may extract email addresses, online account IDs, IP addresses, and different kinds of browser cookies from first-party and third-party websites. Behavioral events processing module 156 may also infer a customer's geo-location information 156b like neighborhood and postal zip code based on IP addresses and store locations.

Customer identities extracted from one or multiple transaction records or behavioral events are gathered and transmitted to identity gateway module 160. Identity gateway 160 may pair related customer identities and add corresponding edge and node metadata between two customer identities as discussed in further detail below. The customer identity pairs augmented by identity gateway 160 with the edge metadata and node metadata are fed into the customer graph engine 165. The customer graph engine 165 may cluster all related customer identities and map each customer identity pair to nodes and edges in a graph 165a. Customer graph engine 165 may then combine the corresponding edge and node metadata for the customer identity pairs and customer identities to their corresponding edges and nodes 165b. Thus, the edge metadata of each customer identity pair and the node metadata of each customer identity may be aggregated and combined to corresponding vertices and edges in the materialized graph such that each vertex or edge in the graph has its corresponding metadata for the needs of different use cases.

Customer graph engine 165 may retrieve a set of linkage rules corresponding to the use case of system 100 from the linkage rule database 140c, and apply the linkage rules to each customer identity in the graph 165c as discussed in further detail below. In this way, the server 105 may determine which customer identities are linked for the purposes of the use case of system 100.

FIG. 2 is a block diagram of an exemplary computing device 200, which may be used to implement server 105 (FIG. 1A). In some embodiments, computing device 200 includes a hardware unit 225 and software 226. Software 226 can run on hardware unit 225 such that various applications or programs can be executed on hardware unit 225 by way of software 226. In some embodiments, the functions of software 326 can be implemented directly in hardware unit 225, e.g., as a system-on-a-chip, firmware, field-programmable gate array (“FPGA”), etc. In some embodiments, hardware unit 225 includes one or more processors, such as processor 230. In some embodiments, processor 230 is an execution unit, or “core,” on a microprocessor chip. In some embodiments, processor 230 may include a processing unit, such as, without limitation, an integrated circuit (“IC”), an ASIC, a microcomputer, a programmable logic controller (“PLC”), and/or any other programmable circuit. Alternatively, processor 230 may include multiple processing units (e.g., in a multi-core configuration). The above examples are exemplary only, and, thus, are not intended to limit in any way the definition and/or meaning of the term “processor.”

Hardware unit 225 also includes a system memory 232 that is coupled to processor 230 via a system bus 234. Memory 232 can be a general volatile RAM. For example, hardware unit 225 can include a 32 bit microcomputer with 2 Mbit ROM and 64 Kbit RAM, and/or a few GB of RAM Memory 232 can also be a ROM, a network interface (NIC), and/or other device(s).

In some embodiments, computing device 200 can also include at least one media output component or display interface 236 for use in presenting information to a user. Display interface 236 can be any component capable of conveying information to a user and may include, without limitation, a display device (not shown) (e.g., a liquid crystal display (“LCD”), an organic light emitting diode (“OLED”) display, or an audio output device (e.g., a speaker or headphones)). In some embodiments, computing device 300 can output at least one desktop, such as desktop 240. Desktop 240 can be an interactive user environment provided by an operating system and/or applications running within computing device 200, and can include at least one screen or display image, such as display image 242. Desktop 240 can also accept input from a user in the form of device inputs, such as keyboard and mouse inputs. In some embodiments, desktop 240 can also accept simulated inputs, such as simulated keyboard and mouse inputs. In addition to user input and/or output, desktop 240 can send and receive device data, such as input and/or output for a FLASH memory device local to the user, or to a local printer.

In some embodiments, display image 242 can be presented to a user on computer displays of a remote terminal (not shown). For example, computing device 200 can be connected to one or more remote terminals (not shown) or servers (not shown) via a network (not shown), wherein the network can be the Internet, a local area network (“LAN”), a wide area network (“WAN”), a personal area network (“PAN”), or any combination thereof, and the network can transmit information between computing device 300 and the remote terminals or the servers, such that remote end users can access the information from computing device 200.

In some embodiments, computing device 200 includes an input or a user interface 250 for receiving input from a user. User interface 250 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and the input interface. In some embodiments, mobile devices, such as tablets, can be used.

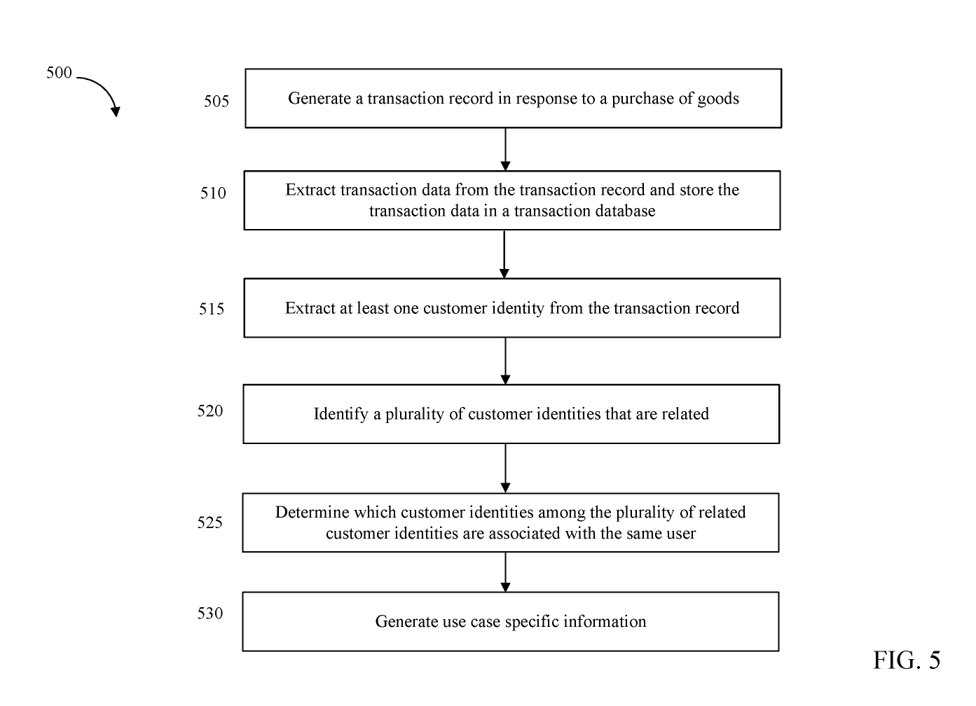

Computing device 200, in some embodiments, can include a database 260 within memory 232, such that various information can be stored within database 260. Alternatively, in some embodiments, database 260 can be included within a remote server (not shown) with file sharing capabilities, such that database 260 can be accessed by computing device 200 and/or remote end users. In some embodiments, a plurality of computer-executable instructions can be stored in memory 232, such as one or more computer-readable storage media 270 (only one being shown in FIG. 2). Computer storage medium 270 includes non-transitory media and may include volatile and nonvolatile, removable and non-removable mediums implemented in any method or technology for storage of information such as computer-readable instructions, data structures, program modules or other data. The instructions may be executed by processor 230 to perform various functions described herein, e.g., steps of the process shown in FIG. 5 or the functions of server 105 as described in FIG. 1.

Referring back to FIG. 1, whenever a user purchases goods from a retailer, a transaction record of the purchase including details of the purchase and/or customer identifiers may be generated and transmitted to server 105. The contents of a transaction record may vary from channel to channel. For example, a user may purchase goods in-store, via in-store terminal 130. Upon completing the purchase, in-store terminal 130 may generate a transaction record including details of the purchase (transaction data) and transmit the transaction record to the server 105. Alternatively, a user may purchase goods from the retailer's online website via online order system 120. The online order system 120 may generate a transaction record that may include details of the purchase as well as the user's online shopping ID, IP address of the computer the user shopped from, and/or one or more HTTP cookies that were stored on the computer the user shopped from. Each of these identifiers may be an example of a customer identity.

Server 105 may serve as the central repository where information from transaction records is processed and stored. Server 105 may continuously receive transaction records generated from a variety of channels (e.g. in-store terminal 130 or mobile device 125) and que them for further processing.

In some embodiments, server 105 may extract transaction data and customer identities from a transaction record. More specifically, server 105 may retrieve the latest transaction record from the que (not shown) and extract transaction data from the transaction record. Transaction data may include the goods purchased, the price of each good, the channel through which the goods were purchased, and the date of purchase among other information. Server 105 may store transaction data extracted from a transaction record in database 140a. Server 105 may proceed to extract customer identities from the transaction record. For example, server 105 may extract HTTP cookies, an IP address of the computer from which the purchase was made, and/or an online shopping ID (in the event of an online purchase). In another example, server 105 may extract a mobile application ID (in the case of a purchase from a mobile application). In some embodiments, server 105 may, in addition to extracting one or more customer identities from the transaction record, generate a customer identity based on information in the transaction record. For example, server 105 may generate a secure token for purchases made through certain mediums (e.g. in-store and online purchases). Server 105 may extract from the transaction record, payment information such as name on the credit card, credit card number, credit card number security code, and credit card expiry date. Server 105 may normalize the payment information as appropriate and apply a secure hash to the payment information to generate a secure token. Thus, the secure token may be a customer identity generated based on information from a transaction record.

In some embodiments, server 105 may also parse and extract behavioral data from behavioral events that occur through a computing device, such as in-store terminal 130 or online order system 120. Examples of online behavioral data include item page views, search keywords, and add-to-cart actions detected through online order system 120. Examples of in-store behavioral data may include store visits, store order pickup, and return actions, detected through in-store terminal 130. Server 105 may store extracted behavioral data in database 140a. Sever 105 may also extract customer identities from behavioral events. Typical customer identities extracted from behavioral events are email address, online account ID, IP address and HTTP cookies from first-party and third-party websites. Server 105 may also infer a customer's geo-location information such as neighborhood and postal zip code based on extracted IP addresses and store locations.

Server 105 may store customer identities that are extracted or generated from a transaction record or behavioral event into customer identity database 140b. Server 105 may associate each customer identity extracted or generated from a transaction record with the transaction data extracted from that transaction record. In response to receiving additional transaction records with customer identities matching a customer identity associated with previously stored transaction data, server 105 may store the transaction data extracted from the additional transaction records along with the previously stored transaction data in database 140a. In this manner, all transaction data stored in database 140a may be associated with one or more customer identities.

Server 105 may analyze the relationships between each of the customer identities in the graph and determine which customer identities are related. Server 105 may initially infer relationships between customer identities to determine which customer identities are related. Such relationships may be explicit, implicit, direct, or indirect. For example, server 105 may infer that a mobile application ID has an explicit relationship to an online shopping ID because the name and credit card information associated with both IDs is the same. In another example, server 105 may determine that an HTTP cookie generated while a user was shopping via online order system 120 and an HTTP cookie generated while the user was shopping on an online store of an affiliate share one or more similar details (e.g. IP address, user name, address, credit card information). Thus, server 105 may infer an indirect relationship between these two HTTP cookies. Similarly, an HTTP cookie generated while the user was shopping on the retailer's online store may have details that directly match the details of the user's online store shopping ID. Therefore, server 105 may identify a direct relationship between the HTTP cookie and the online shopping ID. Server 105 may utilize any suitable algorithm to determine which customer identities are related.

Server 105 may separate the related customer identities associated with a user into pairs based on the type of connection between the customer identities. Server 105 may use any suitable algorithm to pair the customer identities. For example, server 105 may use the Apache Spark GraphX library to pair the related customer identities. In addition, sever 105 may add edge metadata to each customer identity in a pair. Edge metadata may indicate the details of the connection between the customer identities in the pair such as connection type, source of connection and timestamp when connection is established, period of validity, reliability, and confidence level. Server 105 may also add node metadata to each customer identity. Node metadata may include information about the customer identity's type, security, and repeatability, among others. For example, server 105 may furnish a customer identity in the form of an online payment token with node metadata indicating that it is an online payment token, and that it is highly secure and has high repeatability due to the fact that it is based on payment details that are not likely to change frequently. Server 105 may map identity pairs to nodes and edges in a graph according to established graph theory. Server 105 may pre-process the identity pairs to convert them to data structures appropriate for representation as nodes and edges in a graph. Server 105 may integrate the node metadata for each customer identity and edge metadata for each identity pair into the corresponding nodes and edges of the customer identity graph.

Depending on the particular use case (e.g. easy re-order, cross channel personalization), server 105 may retrieve from linkage rule database 140c (as shown in FIG. 1A) a set of linkage rules corresponding to that particular use case and apply the corresponding set of linkage rules to the customer identity graph to determine which customer identities are associated with the same user. In some embodiments, server 105 may retrieve multiple sets of linkage rules, combine the multiple sets and apply the combined set to the identity graph to determine which identities are associated with the same user.

Each different type of customer identity (e.g. online user account ID, HTTP cookie, secure token etc.) may have attributes (node metadata) that differ from attributes of other types of customer identities. For example, the data in various customer identities may be different in terms of form, period of validity, reliability, and security etc. Similarly, the edge metadata between different identity pairs may differ in a similar manner. Thus, linkage rule database 140c (shown in FIG. 1A) may include a plurality of sets of linkage rules for determining whether two or more payment identities are associated with the same user. Each set from the plurality of sets of linkage rules may apply to a different use case scenario. For example, a first set may include linkage rules for an easy re-order system, while a second set may include linkage rules for a cross channel personalization and targeting system. In addition, each set from the plurality of sets may include node and edge criteria. Node criteria may refer to the constraints, or requirements for customer identity attributes for a particular use case scenario. Edge criteria may refer to pre-defined links between different types of customer identities for a particular use case, and thus may determine what kinds of connections between customer identities are appropriate for that particular use case.

For example, an easy re-order system may provide a user who is shopping online with an enhanced view of the online shopping webpage that displays items recently bought from the retailer, regardless of the channel they were purchased through, and allows for the fast and convenient re-purchasing of one or more recently purchased items. The user will not have to re-input their credit card data or double check the existing credit card information. In such a use case, high repeatability, accuracy, and security are required to ensure that the correct products are shown to the user and that the correct credit card information is being used to pay. Thus, the set of linkage rules for an easy re-order system may include node criteria requiring customer identities with high repeatability, accuracy, and security. In this example, only customer identities in the form of online or in-store secure tokens and online shopping IDs may meet the node criteria for the easy re-order use case. In addition, the set of linkage rules for the easy re-order system may include edge criteria that determine which types of connections between customer identities are appropriate for the purposes of that particular use case. In the example of easy re-order, the problem to be solved is the association and aggregation of online and in-store orders. Thus, the edge criteria for the easy re-order use case may require long term connections linking customer identities corresponding to in-store purchases to customer identities corresponding to on-line purchases. In this example, only the connections between in-store secure tokens, online secure tokens, and online shopping IDs may meet the edge criteria of the easy re-order use case.

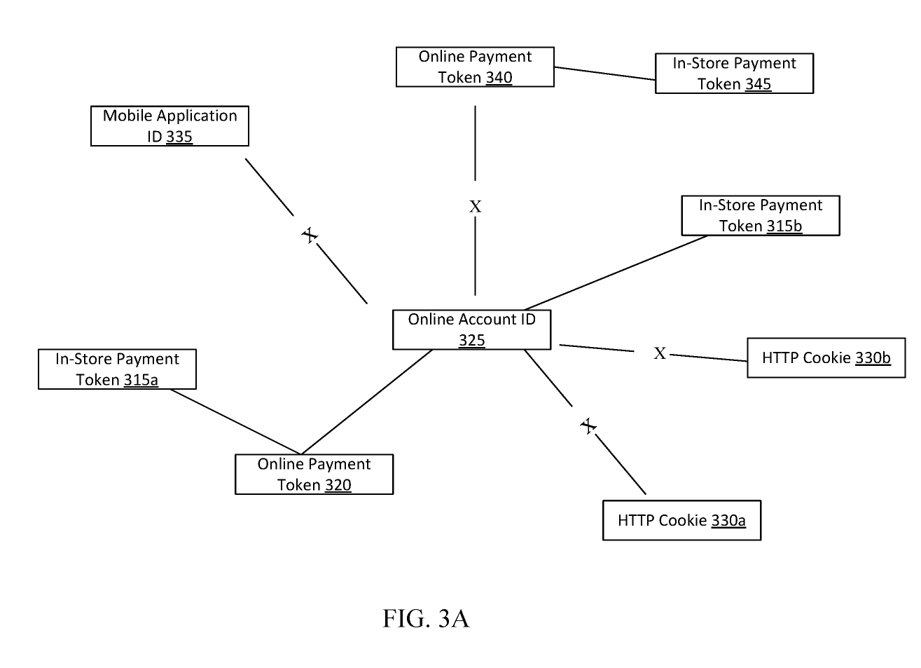

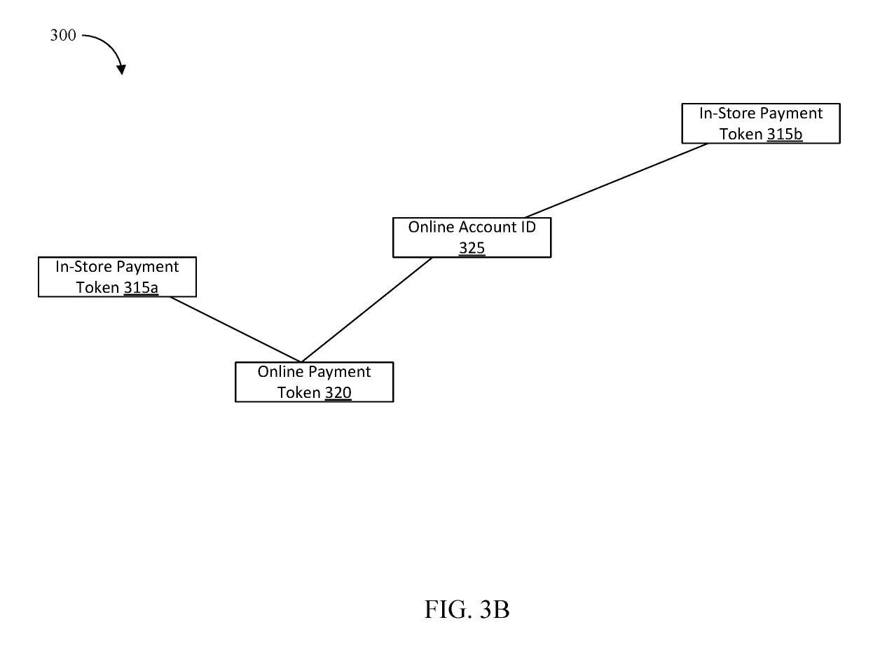

FIG. 3A illustrates a customer identity graph 300 including a number of customer identities that are associated with the same user. Customer identity graph 300 may include in-store payment tokens 315a and 315b, an online payment token 320, an online shopping ID 325, HTTP cookies 330a and 330b, a mobile application ID 335, online payment token 340, and in-store payment token 345. The in-store payment tokens 315a and 315b may originate from in-store terminal 130 (Shown in FIG. 1A). Similarly, the online payment token 320, as well as HTTP cookies 330a and 300b may originate from online order system 120 (shown in FIG. 1A), while the mobile application ID 335 may originate from mobile device 125 (shown in FIG. 1A). Online payment token 340, and in-store payment token 345 may originate from other online order systems and in-store terminals respectively (not shown). In the example of FIG. 3A, server 105 may have retrieved a set of for an easy re-order system as discussed above.

Server 105 may start from in-store token 315, and traverse customer identities on the graph one by one, applying the easy re-order linkage rules retrieved from linkage rule database 140c. Server 105 may keep the customer identities that meet the linkage rules and discard those that do not. Server 105 may determine that in-store payment tokens 315a and 315b and online payment token 320 meet the node criteria of the linkage rules, and further, that the connections between them also meets the edge criteria of the linkage rules (linking in-store and online identities). Server 105 may determine that the connection between online secure token 320 and online account ID 325 meets the edge criteria while online account ID 325 also meets the node criteria. Server 105 may determine that the connections between online secure token 320 and HTTP cookies 330a and 330b meet the edge criteria, but that HTTP cookies 330a and 330b do not meet the node criteria. Similarly, server 105 may determine that mobile application ID 335 and online payment token 340 do not meet the node criteria.

FIG. 3B illustrates the customer identity graph 300 after application of the linkage rules. As can be seen, server 105 has preserved in-store payment tokens 315a and 315b, online payment token 320, and online account ID 325 as they were the only customer identities that met the node and edge criteria of the set of linkage rules for the easy re-order use case. Revised customer graph 300 indicates that the in-store secure token 315, on-line secure token 320, and online shopping ID 325 are all associated with the same user for the purposes of the easy re-order use case.

Referring back to FIG. 1, in some embodiments, server 105 may generate use case specific information. More specifically, server 105 may retrieve from database 140a, the transaction data associated with each customer identity that was determined by server 105 as being associated with the same user identity. In some embodiments, server 105 may retrieve only certain aspects of transaction data (e.g. only the goods previously purchased) based on the use case of the system. Server 105 may then generate use case specific information based on the retrieved transaction data. In some embodiments, server 105 may transmit use case specific information to any appropriate customer interface device (e.g. online order system 120, mobile device 125) for presentation to the user.

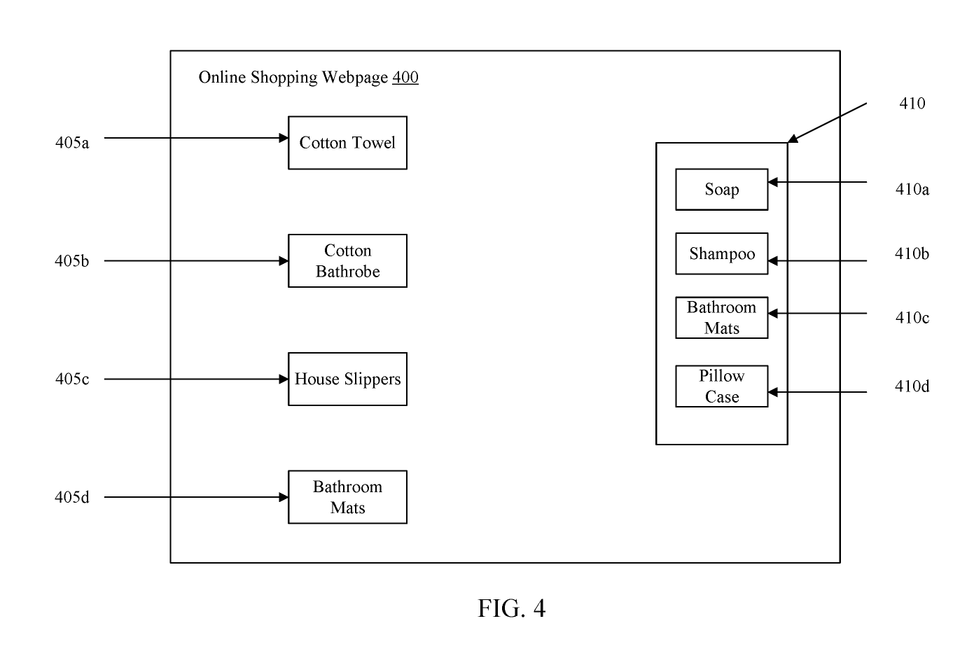

Continuing the example discussed in FIG. 3B, server 105 may retrieve transaction data from database 140a that is associated with in-store secure token 315, on-line secure token 320, and online shopping ID 325. Server 105 may organize the transaction data from these three sources in any appropriate manner. For example, server 105 may organize the goods previously purchased based on the date of purchase, based on the price (e.g. highest to lowest) or in any other appropriate manner. Server 105 may transmit the organized transaction data to be integrated into an online shopping webpage (such as webpage 400, discussed below with respect to FIG. 4) being viewed by the user whenever the user is shopping online.

FIG. 4 illustrates a representation of an on-line shopping webpage 400 with transaction data regarding previous purchases integrated. The online shopping webpage 400 may include objects 405a-d, representing goods that the user is currently viewing and/or considering purchasing. Online shopping webpage 400 may also include a previous purchase bar 410, including objects 410a-d, representing goods that were previously purchased, in-store or online. The objects 410a-d may correspond to previously purchased goods indicated by transaction data associated with linked customer identities. In some embodiments, the objects 410a-d may be links, which can be clicked by the user to automatically re-order the corresponding good.

FIG. 5 illustrates a flow diagram of a method 500 in accordance with some embodiments of the present disclosure. Any appropriate system, such as system 100, as described in FIG. 1, may perform the method 500.

At 505, system 100 may generate a transaction record in response to a purchase of goods. More specifically, whenever a user purchases goods from a retailer, a transaction record of the purchase including details of the purchase and/or customer identifiers may be generated and transmitted to server 105. The contents of a transaction record may vary from channel to channel. For example, a user may purchase goods in-store, via in-store terminal 130. Upon completing the purchase, in-store terminal 130 may generate a transaction record including details of the purchase (transaction data) and transmit the transaction record to the server 105. Alternatively, a user may purchase goods from the retailer's online website via online order system 120. The online order system 120 may generate a transaction record that may include details of the purchase as well as the user's online shopping ID, IP address of the computer the user shopped from, and/or one or more HTTP cookies that were stored on the computer the user shopped from. Each of these identifiers may be an example of a customer identity. Server 105 may receive and que transaction records generated from a variety of channels (e.g. in-store terminal 130 or mobile device 125).

At 510, server 105 may retrieve the latest transaction record from the que (not shown) and extract transaction data from the transaction record. Transaction data may include the goods purchased, the price of each good, the channel through which the goods were purchased, and the date of purchase among other information. Server 105 may store transaction data extracted from a transaction record in database 140a. At 515, server 105 may proceed to extract customer identities from the transaction record. For example, server 105 may extract HTTP cookies, an IP address of the computer from which the purchase was made, and/or an online shopping ID (in the event of an online purchase). In another example, server 105 may extract a mobile application ID (in the case of a purchase from a mobile application). In some embodiments, server 105 may, in addition to extracting one or more customer identities from the transaction record, generate a customer identity based on information in the transaction record. For example, server 105 may generate a secure token for purchases made through certain mediums (e.g. in-store and online purchases). Server 105 may extract from the transaction record, payment information such as name on the credit card, credit card number, credit card number security code, and credit card expiry date. Server 105 may normalize the payment information as appropriate and apply a secure hash to the payment information to generate a secure token. Thus, the secure token may be a customer identity generated based on information from a transaction record.

In some embodiments, server 105 may also parse and extract behavioral data from behavioral events that occur through a computing device, such as in-store terminal 130 or online order system 120. Examples of online behavioral data include item page views, search keywords, and add-to-cart actions detected through online order system 120. Examples of in-store behavioral data may include store visits, store order pickup, and return actions, detected through in-store terminal 130. Server 105 may store extracted behavioral data in database 140a. Sever 105 may also extract customer identities from behavioral events. Typical customer identities extracted from behavioral events are email address, online account ID, IP address and HTTP cookies from first-party and third-party websites. Server 105 may also infer a customer's geo-location information such as neighborhood and postal zip code based on extracted IP addresses and store locations.

Server 105 may store customer identities that are extracted or generated from a transaction record or behavioral event into customer identity database 140b. Server 105 may associate each customer identity extracted or generated from a transaction record with the transaction data extracted from that transaction record. In response to receiving additional transaction records with customer identities matching a customer identity associated with previously stored transaction data, server 105 may store the transaction data extracted from the additional transaction records along with the previously stored transaction data in database 140a. In this manner, all transaction data stored in database 140a may be associated with one or more customer identities.

At 520, server 105 may identify a plurality of customer identities that are related. Server 105 may analyze the relationships between each of the customer identities in the graph and determine which customer identities are related. Server 105 may initially infer relationships between customer identities to determine which customer identities are related. Such relationships may be explicit, implicit, direct, or indirect. For example, server 105 may infer that a mobile application ID has an explicit relationship to an online shopping ID because the name and credit card information associated with both IDs is the same. In another example, server 105 may determine that an HTTP cookie generated while a user was shopping via online order system 120 and an HTTP cookie generated while the user was shopping on an online store of an affiliate share one or more similar details (e.g. IP address, user name, address, credit card information). Thus, server 105 may infer an indirect relationship between these two HTTP cookies. Similarly, an HTTP cookie generated while the user was shopping on the retailer's online store may have details that directly match the details of the user's online store shopping ID. Therefore, server 105 may identify a direct relationship between the HTTP cookie and the online shopping ID.

Server 105 may separate the related customer identities associated with a user into pairs based on the type of connection between the customer identities. In addition, sever 105 may add edge metadata to each customer identity in a pair. Edge metadata may indicate the details of the connection between the customer identities in the pair such as connection type, source of connection and timestamp when connection is established, period of validity, reliability, and confidence level. Server 105 may also add node metadata to each customer identity. Node metadata may include information about the customer identity's type, security, and repeatability, among others. For example, server 105 may furnish a customer identity in the form of an online payment token with node metadata indicating that it is an online payment token, and that it is highly secure and has high repeatability due to the fact that it is based on payment details that are not likely to change frequently. Server 105 may use any suitable algorithm to pair the related customer identities. For example, server 105 may use the Apache Spark GraphX library to pair the related customer identities.

Server 105 may map identity pairs to nodes and edges in a graph according to established graph theory. Server 105 may pre-process the identity pairs to convert them to data structures appropriate for representation as nodes and edges in a graph. Server 105 may integrate the node metadata for each customer identity and edge metadata for each identity pair into the corresponding nodes and edges of the customer identity graph.

At 525, server 105 may determine which of the identities are associated with a user for the purposes of a particular use case. More specifically, depending on the particular use case (e.g. easy re-order, cross channel personalization), server 105 may retrieve from linkage rule database 140c (as shown in FIG. 1A) a set of linkage rules corresponding to that particular use case and apply the corresponding set of linkage rules to the customer identity graph to determine which customer identities are associated with the same user for the purposes of the particular use case. In some embodiments, server 105 may retrieve multiple sets of linkage rules, combine the multiple sets and apply the combined set to the identity graph to determine which identities are associated with the same user.

At 530, server 105 may generate use case specific information. More specifically, server 105 may retrieve from database 140a, the transaction data associated with each customer identity that was determined by server 105 as being associated with the same user identity. In some embodiments, server 105 may retrieve only certain aspects of transaction data (e.g. only the goods previously purchased) based on the use case of the system. Server 105 may then generate use case specific information based on the retrieved transaction data. In some embodiments, server 105 may transmit use case specific information to any appropriate customer interface device (e.g. online order system 120, mobile device 125) for presentation to the user.

The various embodiments described herein may employ various computer-implemented operations involving data stored in computer systems. For example, these operations may require physical manipulation of physical quantities usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. The computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A system configured to:
receive at least one transaction record generated in response to a purchase of goods;
extract transaction data from the at least one transaction record and store the transaction data in a transaction database;
extract at least one customer identity from the at least one transaction record and store the at least one customer identity in a customer identity database, wherein the transaction data extracted from the at least one transaction record is associated with the at least one customer identity;
identify a plurality of customer identities that are stored in the customer database that are related to the user;
determine which of the identified plurality of related customer identities are applicable to a use case of the system; and
generate use case specific information based, at least in part, on the transaction data associated with the determined one or more customer identities.

2. The system of claim 1, further configured to:
extract payment information from the transaction record;
normalize the payment information; and
apply a secure hash algorithm to the payment information to generate a secure token, wherein the secure token is a customer identity among the at least one customer identities.

3. The system of claim 1, wherein said system is configured to determine which of the identified plurality of customer identities are applicable to the use case by being configured to:
generate a graph based on the plurality of customer identities that are related to the user;
retrieving a set of linkage rules, wherein the set of linkage rules retrieved is based on the use case of the system; and
applying the linkage rules to each customer identity in the graph and discarding each customer identity that does not meet the set of linkage rules.

4. The system of claim 3, wherein the set of linkage rules comprise:
a predefined set of attributes criteria for customer identities; and
a predefined set of customer identity link criteria for customer identities.

5. The system of claim 1, wherein at least one of the plurality of customer interface devices is an online order system and the system is further configured to transmit the use case specific information to the online order system.

6. The system of claim 5, wherein the online order system is further configured to integrate the use case specific information into an online shopping experience of the user.

7. The system of claim 1, wherein said system is configured to identify a plurality of customer identities related to the user by being configured to identify customer identities that have an explicit, implicit, direct, or indirect relationship with each other.

8. A method comprising:
receiving at least one transaction record generated in response to a purchase of goods;
extracting transaction data from the at least one transaction record and storing the transaction data in a transaction database;
extracting at least one customer identity from the at least one transaction record and storing the at least one customer identity in a customer identity database, wherein the transaction data extracted from the at least one transaction record is associated with the at least one customer identity;
identifying a plurality of customer identities that are stored in the customer database that are related to the user;
determining which of the identified plurality of related customer identities are applicable to a use case of the system; and
generating use case specific information based, at least in part, on the transaction data associated with the determined one or more customer identities.

9. The method of claim 8, further comprising:
extracting payment information from the transaction record;
normalizing the payment information; and
applying a secure hash algorithm to the payment information to generate a secure token, wherein the secure token is a customer identity among the at least one customer identities.

10. The method of claim 8, wherein determining which of the identified plurality of customer identities are applicable to the use case comprises:
generating a graph based on the plurality of customer identities that are related to the user;
retrieving a set of linkage rules, wherein the set of linkage rules retrieved is based on the use case of the method; and
applying the linkage rules to each customer identity in the graph and discarding each customer identity that does not meet the set of linkage rules.

11. The method of claim 10, wherein the set of linkage rules comprise:
a predefined set of attributes criteria for customer identities; and
a predefined set of customer identity link criteria for customer identities.

12. The method of claim 8, further comprising transmitting the use case specific information to an online order system for integration into an online shopping experience of the user.

13. The method of claim 8, wherein identifying a plurality of customer identities that are related to the user comprises identifying customer identities that have an explicit, implicit, direct, or indirect relationship with each other.

14. A non-transitory computer readable medium having instructions stored thereon for synchronizing a user's shopping experiences over a plurality of channels, wherein the instructions, when executed by a processor cause a device to perform operations comprising:
receiving at least one transaction record generated in response to a purchase of goods;
extracting transaction data from the at least one transaction record and storing the transaction data in a transaction database;
extracting at least one customer identity from the at least one transaction record and storing the at least one customer identity in a customer identity database, wherein the transaction data extracted from the at least one transaction record is associated with the at least one customer identity;
identifying a plurality of customer identities that are stored in the customer database that are related to the user;
determining which of the identified plurality of related customer identities are applicable to a use case of the system; and
generating use case specific information based, at least in part, on the transaction data associated with the determined one or more customer identities.

15. The non-transitory computer readable medium of claim 14, wherein execution of the instructions causes the device to perform operations further comprising:
extracting payment information from the transaction record;
normalizing the payment information; and
applying a secure hash algorithm to the payment information to generate a secure token, wherein the secure token is a customer identity among the at least one customer identities.

16. The non-transitory computer readable medium of claim 14, wherein determining which of the identified plurality of customer identities are applicable to the use case comprises:
generating a graph based on the plurality of customer identities that are related to the customer;
retrieving a set of linkage rules, wherein the set of linkage rules retrieved is based on the use case of the method; and
applying the linkage rules to each customer identity in the graph and discarding each customer identity that does not meet the set of linkage rules.

17. The non-transitory computer readable medium of claim 16, wherein the set of linkage rules comprise:
a predefined set of attributes criteria for customer identities; and
a predefined set of customer identity link criteria for customer identities.

18. The non-transitory computer readable medium of claim 14, wherein execution of the instructions further causes the device to transmit the use case specific information to an online order system for integration into an online shopping experience of the user.

19. The non-transitory computer readable medium of claim 14, wherein identifying a plurality of customer identities that are related to the user comprises identifying customer identities that have an explicit, implicit, direct, or indirect relationship with each other.

20. The non-transitory computer readable medium of claim 17, wherein the set of customer identity link criteria comprise predefined links between different customer identities.
